(19) United States
(12) Patent Application Publication
(10) Pub. No.: US 2009/0147005 A1
(43) Pub. Date: Jun. 11, 2009

(54) Methods, systems and computer readable media facilitating visualization of higher dimensional datasets in a two-dimensional format

(76) Inventor: Robert H. Kincaid, Half Moon Bay, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/999,548

(22) Filed: Dec. 5, 2007

(51) Int. Cl. G06T 11/20

(52) U.S. Cl. 345/440

(57) ABSTRACT

Methods, systems and computer readable media for representing multidimensional data derived from molecular separation processing to resemble a two-dimensional display created from a molecular separation process producing data values for two different properties. Multidimensional data having values for at least three different properties of molecules separated by the molecular separation processing is received. Data values for a first of the at least three different properties are plotted relative to data values for a second of the at least three different properties in a two-dimensional plot. The first and second properties are the same properties as those plotted in the two-dimensional display created from the molecular separation process producing values for two different properties. Data values for a third of the properties are represented by varying the graphic representation of the data values plotted for the first and second of the properties.

### BACKGROUND OF THE INVENTION

Multidimensional liquid chromatography (MDLC) has long sought to be a replacement for two-dimensional (2D) gel electrophoresis methods. Although MDLC methods may be considered to provide superior separations of samples relative to separations provided by 2D gel electrophoresis methods, they have generally not been adopted by scientists. For example, scientists working in the field of proteomics generally continue to prefer use of 2D gel electrophoresis methods over MDLC methods for separating protein samples.

One reason for the general lack of adoption of use of MDLC techniques over 2D gel electrophoresis techniques is believed to be the difference in the scales/units to measure and display the results of each. A plot of results from the performance of 2D gel electrophoresis typically has a Y-axis having units of molecular weight (MW) and a X-axis having units of pI (measurement of isoelectric point). A plot of results from the performance of MDLC, in contrast, is generally more difficult for the user to interpret (particularly a user familiar with interpreting 2D gel electrophoresis plots) quantitatively with respect to physical properties of the molecules detected, and are not directly comparable to the pI-MW plots from 2D gel electrophoresis. A plot of results from the performance of MDLC typically includes two retention time data axes, such as SAX HPLC retention time and reverse phase liquid chromatography retention time axes, in addition to a third data axis for signal intensity, for example. The third dimension data (signal intensity) can be obtained by various types of detectors, such as an ultraviolet wavelength detector for absorbance or fluorescences, a total ion current plot of mass spectrometry data, etc. Accordingly, researchers that have been accustomed to reading separation results as plots of pI vs. MW find it cumbersome and more time consuming to try and obtain the information that they are interested in obtaining from an MDLC plot, and therefore prefer to continue to use 2D gel electrophoresis methods and read and interpret pI vs. MW plots.

2-D electrophoresis methods begin with a 1-D electrophoresis process and then separate the molecules being tested by a second property in a direction along a second axis perpendicular to the first axis/direction of the 1-D electrophoresis process. When the molecules are proteins, the two dimensions that the proteins are separated into are isoelectric point (pI) and mass (MW). To separate the proteins by isoelectric point, a gradient of pH is applied to a gel and an electric potential is applied across the gel, making one end of the gel more positively charged than the other end. At all pH locations other than that equaling an isoelectric point of a protein, the protein will be charged. Accordingly, if the protein is positively charged, it is drawn towards the more negatively charged end of the gel and if the protein is negatively charged, it will be drawn toward the more positively charged end of the gel. The pulling of each protein molecule continues until each protein reaches the location where it is at its isoelectric point, the location where the overall charge on that molecule is substantially zero. In the first dimension, prior to separating by isoelectric point, the gel acts like a molecular sieve when voltage is applied, so that proteins are separated by molecular weight, with the higher molecular weight proteins being retained higher on the gel and the lower molecular weight proteins being able to pass through the gel and reach lower regions of the gel. The proteins, after being separated in two dimensions are then typically stained, such as using silver and coomassie staining, for example, to provide results like those illustrated in the exemplary 2-D electrophoresis plot 100 shown in FIG. 1. Note that a significant amount of smearing 102 is typically present in these plots, which substantially reduces accuracy and precision of results obtained from 2-D electrophoresis plots.

There is a continuing need for systems, methods and computer software that will facilitate the interpretation of MDLC data, making it easier to interpret. There is a continuing need to present MDLC data in a manner that lowers barriers to the acceptance of MDLC for use, particularly by those that are already accustomed to analyzing 2-D data plots such as plots from 2D gel electrophoresis methods.

### BRIEF DESCRIPTION OF THE DRAWINGS

FIG. 1A illustrates a typical plot formed from a 2-D electrophoresis processing of a protein sample.

FIG. 1B shows an example of a typical plot from performance of MDLC.

FIG. 2 schematically illustrates a process by which molecular separation of proteins is performed using MDLC.

FIG. 3 illustrates a process for representing multidimensional data derived from molecular separation processing to resemble a two-dimensional display created from a molecular separation process that produces data values for only two different properties.

FIG. 4 illustrates a display produced by an embodiment of the method of FIG. 3 in which a plot of molecular weight (Y-axis) vs. pI values (X-axis) has been plotted for a protein sample processed by MDLC techniques such as those described with regard to FIG. 2.

FIG. 5 illustrates a 3-D plot of data values for the first and second properties corresponding to the first and second properties plotted in the 2-D plot of FIG. 4, with data values for a third property plotted along a Z-axis.

FIG. 6 illustrates a display of a user interface on which a 2-D plot 400 is displayed.

FIG. 7 illustrates a user interface with both a 2-D plot and a 3-D plot displayed.

FIG. 8 illustrates an embodiment of a process for representing multidimensional data derived from molecular separation processing to resemble a two-dimensional display created from a molecular separation process producing data values for two different properties and for manipulating representations resembling the two-dimensional display via a representation of at least a third dimension of data.

FIG. 9 illustrates an embodiment of a process for displaying and manipulating multidimensional data derived from molecular separation processing.

FIG. 10 illustrates a typical computer system in accordance with an embodiment of the present invention.

### DETAILED DESCRIPTION OF THE INVENTION

Before the present methods, systems and computer readable media are described, it is to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a plot” includes a plurality of such plots and reference to “the data value” includes reference to one or more data values and equivalents thereof known in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Gel electrophoresis is a technique in which charged molecules, such as protein or DNA, are separated according to physical properties as they are forced through a gel by application of a voltage. Proteins can be separated using polyacrylamide gel electrophoresis (PAGE) to characterize individual proteins in a complex sample or to examine multiple proteins in a single sample, see piercenet.com/Proteomics/browse.cfm?fldID=2158847-2D72-475F-A5B9-B236EC5B641E. Two-dimensional PAGE separates proteins by isoelectric point (pI) in the first dimension and by mass in the second dimension.

Acrylamide is typically used for preparing electrophoretic gels to separate proteins by size. Due to the nature of the separation, as the samples are driven through the gel, streaking occurs, and therefore the results of the data values obtained from this process are not point-accurate, as the streaks provide more of a range of values.

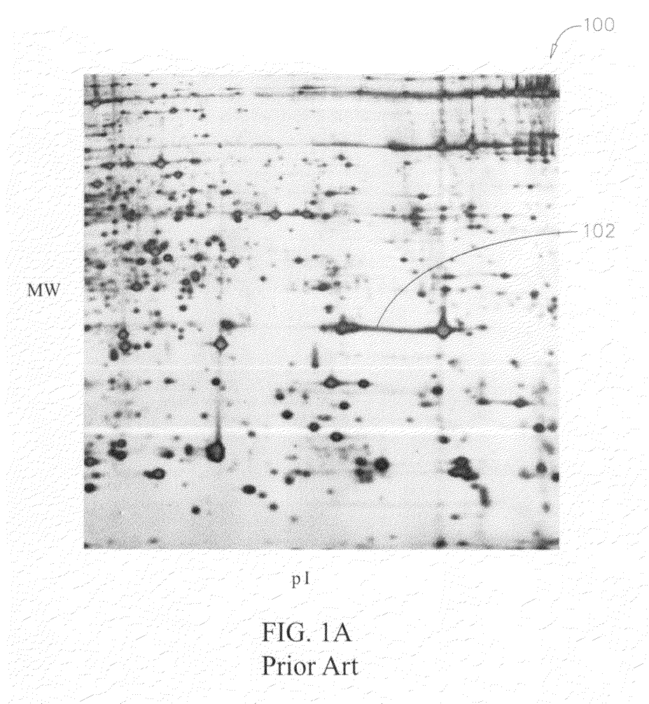

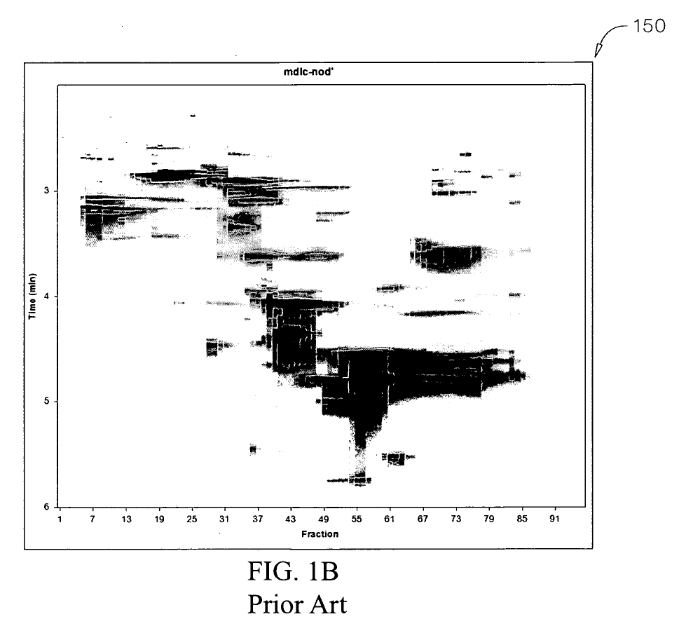

MDLC methods provide enhanced separation of the samples, relative to electrophoresis methods. FIG. 1B shows an example of a typical plot from performance of MDLC, showing only the SAX (fraction) and RP (reverse phase time) axes, where the reverse phase time is the retention time of the Reverse Phase dimension (i.e., second liquid chromatography process) and fraction refers to the fraction number collected from the Strong Anion Exchange (SAX) dimension (i.e., first liquid chromatography process). The MDLC protocol that was used to generate the plot of FIG. 1B did manual fraction collection of the first dimension. Accordingly, the fractions were collected as the sample was run through the SAX column. The output of the SAX column was collected into a microwell plate, with each fraction collected corresponding to a small time range in the SAX (fraction) dimension. Each fraction collected was then run through an RP (reverse phase liquid chromatography) column as a separate liquid chromatograph (LC) run to obtain the second dimension separation. The values recorded are in time order, so they correspond to retention times. However, MDLC processes according to the present invention can also be run in an automated fashion, sometime referred to as “on-line” methods where the output of the first column goes directly to a second column with fully automated fraction collection. As can be readily observed in FIG. 1B, streaking also occurs in currently available MDLC plots.

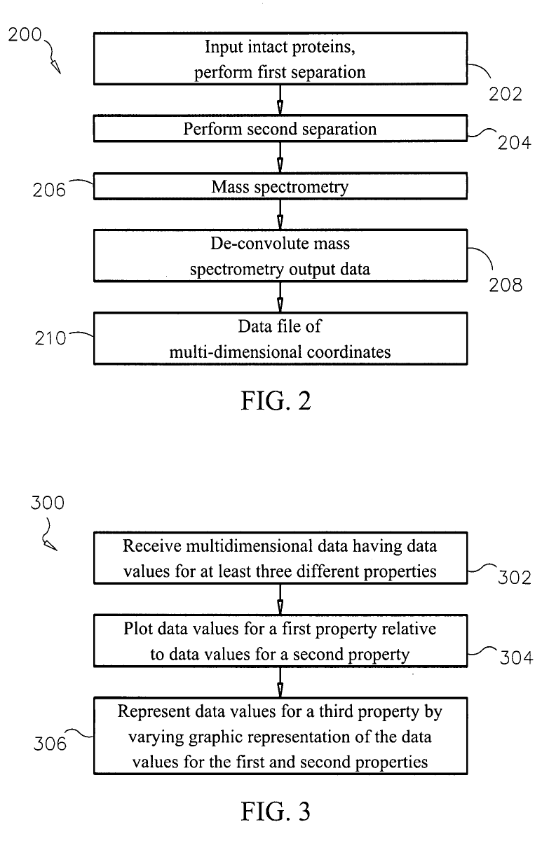

In contrast, the present invention provides molecular weight (MW) versus pI plots that generally do not exhibit streaking due to computations performed from data produced from performing mass spectrometry on the sample. FIG. 2 schematically illustrates a process 200 by which molecular separation of proteins are performed using MDLC. At event 202, intact proteins (which may be immunodepleted) are input to a first instrument for performing the first separation in the process. This instrument may be a modified ion exchange column, Off-Gel electrophoresis (OGE) instrument (Agilent Technologies, Inc.) or other instrument to perform a pI-based fractionation of the proteins. The effluent from this event can either be captured as discrete fractions for a second separation process (e.g., liquid chromatography (LC) separation performed offline) or an online arrangement can be provided using trapping columns or fast column switching to perform the second separation online. In either case, a second separation is performed at event 204, such as by reverse-phase chromatography.

The effluent of the second separation event is inputted to a mass spectrometer, and the effluent is processed to provide mass data (event 206) for fractions of the proteins that were originally inputted at event 202. The data output by the mass spectrometer is de-convoluted at event 208 into protein mass data that is much more accurate than mass data values that can be read from an output of an electrophoresis process. This de-convoluted data is used to determine the molecular weights of each detected component, most of which should be proteins, given the input sample in this embodiment. By properly tracing collected fractions or retention times, each de-convoluted putative protein can be assigned a molecular weight, a pI value, and a second dimension retention time, as well as an abundance value.

In order to encourage use of this dramatically more accurate data (relative to that provided by electophoresis methods) the present invention processes the data to display it in a less complex, more user friendly view, relative to the typically two-dimensional liquid chromatography results that are currently provided when using MDLC techniques. Specifically, rather than plotting the first and second dimension retention times, the present invention converts the MDLC data to pI values and plots the mass values obtained from the mass spectrometry and de-convolution procedures against the calculated pI values.

There are at least several different methods by which pI values can be calculated. In one method, a gradient can be constructed such that liquid chromatography retention times can be converted to approximate values of pI/pH of the sample molecules. Another technique provides a pH meter in line with the liquid chromatography output, so that pH values are read in conjunction with retention times and correlated therewith. A third alternative uses standards to make a calibration curve for each liquid chromatography run, which can be used to convert retention times to pI values. As another alternative or additional technique, performance of MS/MS at the MS stage of the process can identify the particular proteins in the sample, thereby identifying the protein in question and pI can therefore be calculated theoretically, entirely from the predicted protein sequence, without need to rely on the retention times.

FIG. 3 illustrates a process 300 for representing multidimensional data derived from molecular separation processing to resemble a two-dimensional display created from a molecular separation process that produces data values for only two different properties. At event 302 the system receives multidimensional data having values for at least three different properties of molecules separated by the molecular separation processing. At event 304, data values for a first of the at least three different properties are plotted relative to data values for a second of the at least three different properties in a two-dimensional plot. The first and second of the properties are the same properties as those plotted in the two-dimensional display created from a molecular separation process producing values for two different properties.

At event 306, data values for a third of the at least three different properties are represented by varying the graphic representation of the data values plotted for the first and second of the properties.

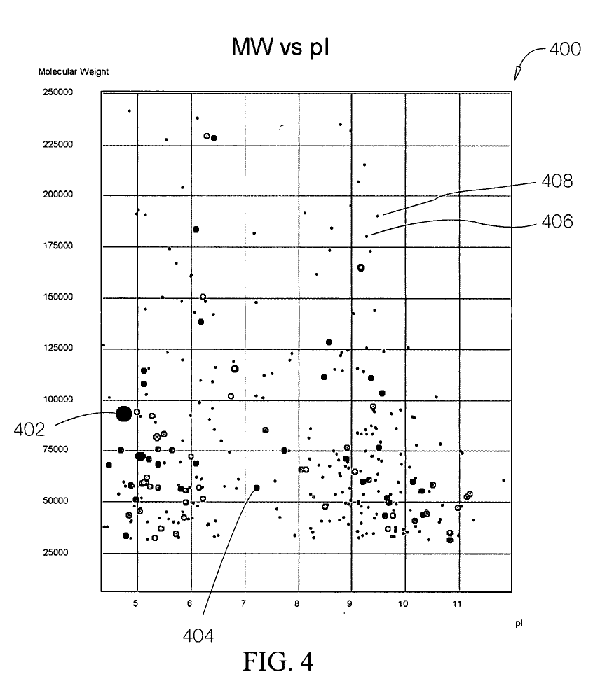

FIG. 4 illustrates a display produced by an embodiment of the method of FIG. 3 in which a plot of molecular weight (Y-axis) vs. pI values (X-axis) has been plotted for a protein sample processed by MDLC techniques, such as those described with regard to FIG. 2. In this embodiment, the plot 400 has been generated as a two-dimensional plot of molecular weight and pI values to resemble a plot that is typically made using results form an electrophoresis process on a protein sample. By plotting pI vs. molecular weight, the visualization (plot) 400 is directly comparable to the familiar 2-D gel views resulting from electrophoresis, like that shown in FIG. 1. Accordingly, users that are already familiar with and practiced at interpreting 2-D gel plots for 2-D gel proteomic research will find plot 400 familiar and comfortable to use, and will likely be more apt to use MDLC data presented in this manner.

Further, the users will also be able to find familiar proteomic landmarks in the same relative locations on plot 400 that they are used to finding on the 2-D gel plots. However, since the data in plot 400 is much more accurate and digitized, users will be provided with more accurate and reliable data. For example, vastly improved mass resolution is provided by the MDLC processing and plot 400, relative to 2-D gel mass data. Since the data is also already digitized, it is readily amenable to computational data analysis. Results from the 2-D gel processes require less precise imaging techniques to extract essentially analog features for conversion into a digital format. The mass data values along the Y-axis of plot 400 show absolutely no smearing, in contrast to mass values obtained from 2-D gels, and are thus much more accurate, as molecular weight values are obtained from mass spectrometry processing of the molecules, and not from a migration or retention time, which is subject to diffusion spreading.

FIG. 4 further illustrates how synthetic displays such as the plot 400 shown can incorporate more than two dimensions (properties) of the sample into a 2-D display. As shown, the data values are displayed as circles having varying sizes according to the abundance values of the proteins being represented. Thus, for example, data value 402 represents a protein having a much higher abundance than the protein represented by data value 404. Additionally, in this example, the shades of the circles representing the data values are varied according to a measure of reliability. The plotting/indication of abundance values by size differences or other graphically variations mimics the two-dimensional gel images where spot size is generally proportional to abundance. Additionally, by plotting a fourth dimension/variable, by color or intensity variations, this provide additional information that is not available on gel images. Accordingly, an intuitive display is provided that is readable/interpretable in a similar manner to a 2-D gel display, with the additional advantage of having additional information embedded in the display according to the present invention.

As to measures of reliability, when the mass (MW) is determined by a single MS stage (where the process includes two LC stages and an MS stage), a rough measure of confidence can be constructed based on the number of individual ions (isotopes and charge states) that are grouped and associated with a particular measured mass (parent neutral mass). Thus, an indication of reliability can be provided on plot 400 that is proportional to the number of ions contributing to each data point. This indication might be shading, ranges of color hues, size of the data points displayed, etc. When MS/MS processing is used, most MS/MS softwares report the total number of fragment spectra acquired that were associated with each identified protein. This spectra count for each protein can also be used as a confidence measure, where more spectra increases the confidence level. Further additionally, most MS/MS softwares report some type of confidence score or p-value based on the statistical measures provided with the MS/MS software. These values indicate the confidence in the reported identification and are provided for each identified protein, along with the mass of the protein. These values may also be indicated as confidence values on plot 400 in any of the manners discussed above.

Additionally or alternatively, other metadata from categories of metadata associated with the mass (MW) of the molecules may be represented on a plot such as plot 600, using various indicators, including, but not limited to: shading, color variations, size variations, different shapes etc. Other categories include, but are not limited to: gene ontology notations, molecular function, other protein classifications, sample classes (e.g., “diseased” vs. “healthy”; “treated” vs. “untreated”, “aggressive” vs. “benign”, etc.), etc.

Accordingly, in one example, a darker dot, such as 406, for example, indicates a data value that a user can trust to be relatively more reliable than a data value represented by a lighter dot, such as 408, for example. This shading can be on a continuous grey scale to represent a continuous range of reliability values, and the sizing can also be changed on a scale to represent many different abundance values over the entire range of abundance values represented. Further, these representation techniques are not limited to abundance and reliability, as other properties of the data may be alternatively or additionally and similarly be represented on the 2-D plot.

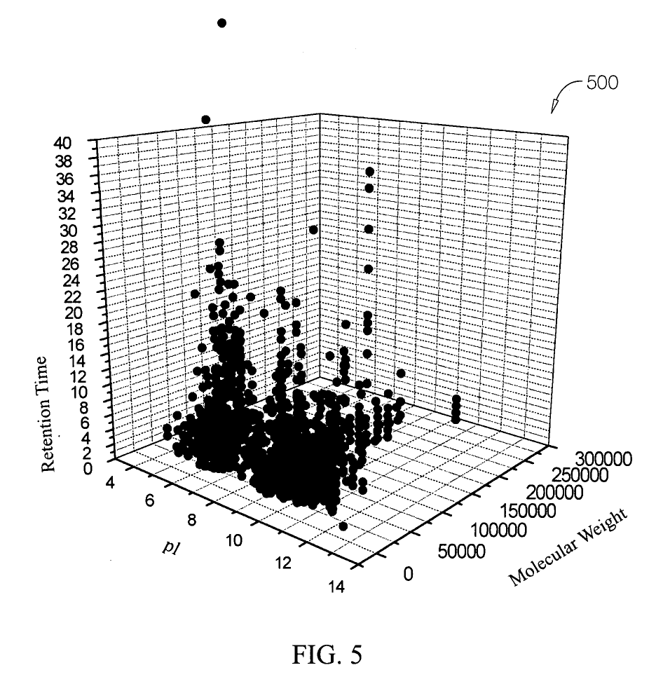

Additionally, the present invention may also provide a 3-D plot 500 of data values for the first and second properties corresponding to the first and second properties plotted in the 2-D plot, with data values for a third property plotted along a Z-axis, as illustrated in FIG. 5. In this example, pI values are plotted along the X-axis, molecular weight values are plotted along the Y-axis, and retention time values from a second separation (e.g., see FIG. 2, event 204), are plotted along the Z-axis. Such retention times can be retention times from a reverse-phase liquid chromatography process, or other second separation process. However, 3-D displays such as plot 500 are typically difficult to navigate and explore. Further, a considerable amount of data occlusion may result, as is apparent in FIG. 5, when all of the data values are plotted in three dimensions. This can also happen in two dimensions, but is often exacerbated in the 3-D plot.

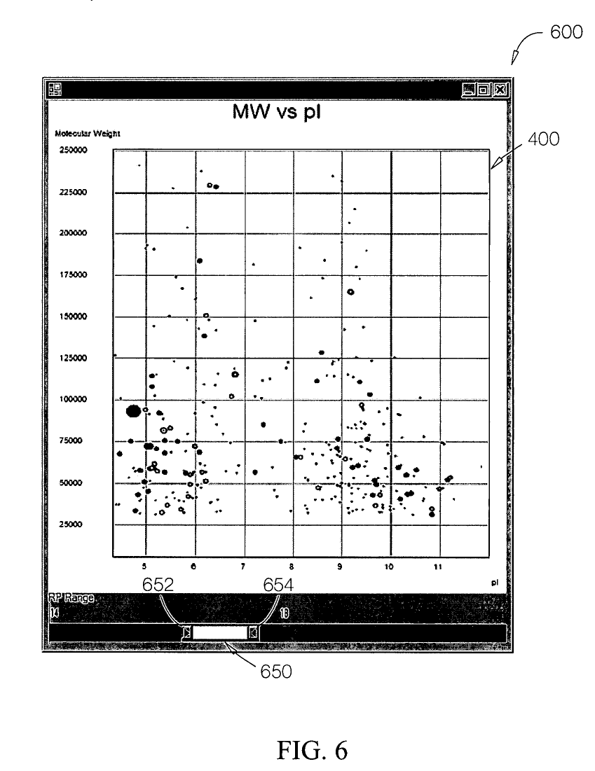

One way to reduce the visual complexity of the displayed data is to maintain a 2-D plot 400, and filter out a portion of the data values by selecting property values from a third property (e.g., corresponding to the third axis of the 3-D plot) to select a subset of the full data for display on the 2-D plot 400. FIG. 6 illustrates a display of a user interface 600 in which a 2-D plot 400, like that described above with regard to FIG. 4, is displayed. Additionally, a user-selectable selection feature 650 is provided by which a user can select a range of values from a set of data values representing a third property of the dataset. In the example shown in FIG. 6, the third property is the reverse-phase retention time of the protein in the second separation phase. Accordingly, the user can select a range of revere-phase retention time values, and only those data values for pI and molecular weight that correspond to the selected reverse-phase retention time values are displayed on the 2-D plot 400. In the example shown, the only pI and mass values plotted are for those proteins have a reverse-phase retention time in the range of about 16.5 to about 17.25 seconds. As a result, the reduced data set is less cluttered and occluded, and can be more readily analyzed by the user.

As shown, selection feature 650 comprises a slider, with both left 652 and right 654 ends of the slider being adjustable in the left and right directions, so that the user can readily set any range of reverse-phase retention times desired over the entire range of reverse-phase retention time. Additionally, or alternatively, the entire slider can be moved to select the same range span over a different location on the entire range of values of the axis that is being filtered. The present invention is not limited to use of a slider as a selection feature 650 of course, as other alternative features may be provided to accomplish the same function. For example, the user could be provided with two fillable boxes where the user could enter the starting and ending values of the range of retention time values to be selected, or other features may be provided, as would be readily apparent to one of ordinary skill in the art of software design and user interface display design. Likewise, the third property over which range values are selected is not limited to retention times, as values of any other property of the sample data values could be assigned to the axis to be filtered. Advantageously, when filtering on reverse-phase retention times, there is some correspondence between reverse-phase retention times in a reverse-phase liquid chromatography column and polarity of the protein, so filtering in this manner provides some meaningful correspondence to the relevant molecular properties plotted in the 2-D plot 400. The filtering described above can be applied dynamically and interactively, so that the user can vary the selected ranges, each time reviewing the results via the user interface 600.

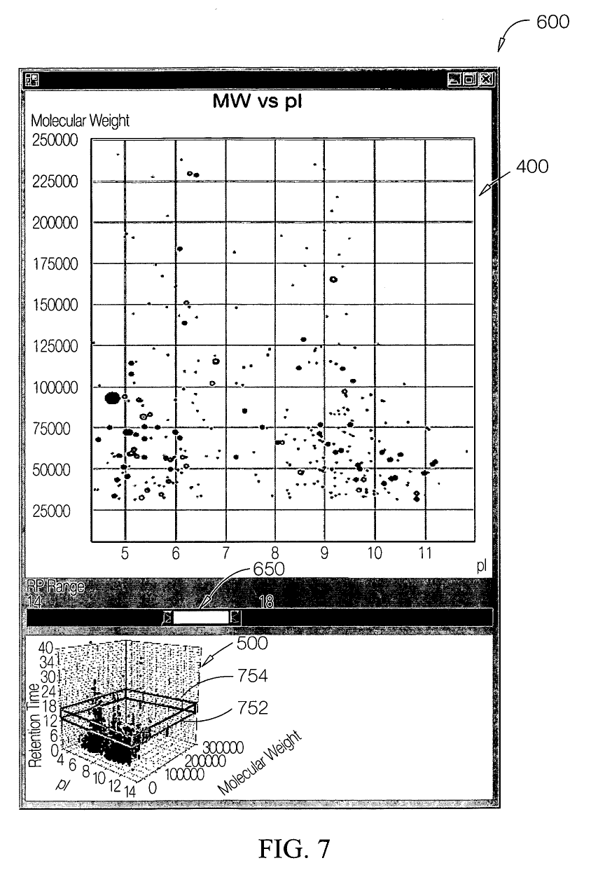

The 3-D plot 500 can be displayed together with the 2-D plot 400 on user interface 600 to provide the user with further perspective as to what the 2-D plot is showing relative to at least a third property of the data. Further alternatively, when a selection feature 650 is provided for filtering the data as described above, the range of data that is displayed on the 2-D plot can be highlighted, outlined, or otherwise indicated on the 3-D plot 500 as illustrated in FIG. 7. Thus, in FIG. 7, the lower end value of the range set by 652 is outlined by outline 752 and the upper range value 654 is outlined by outline 754 on plot 500, to provide the user with a perspective as to what portion of the entire dataset is being currently displayed on plot 400. By altering the selection via selection feature 650, this also alters the placement of the outlines 752 and 754 concurrently with changing the data that is displayed in view 400 as the views 400 and 500 are linked.

Further alternatively or additionally, the 3-D plot 500 may be used for range selection/filtering. For example, the outlines 752, 754 may be provided to be adjustable by a user by clicking and dragging them. Further, both outlines could be moved together in the same way that the entire slider 650 can be moved as described. This adjustable, filtering functionality of the 3-D plot 500 could be provided in lieu of feature 650, or in addition thereto, so that the user could filter in either way.

Because the plots 400,500 described herein are digitized, they do not have to be provided with linear axis scales. Thus, in certain situations, it may be convenient to plot log values of the molecular weights on the Y-axis versus the linear pI values on the X-axis to more evenly distribute the data values across the display. Alternatively, it may be desirable to generate non-linear scaling on the molecular weight and/or the pI axes to more closely replicate the coordinate space of typical 2-D gel plots.

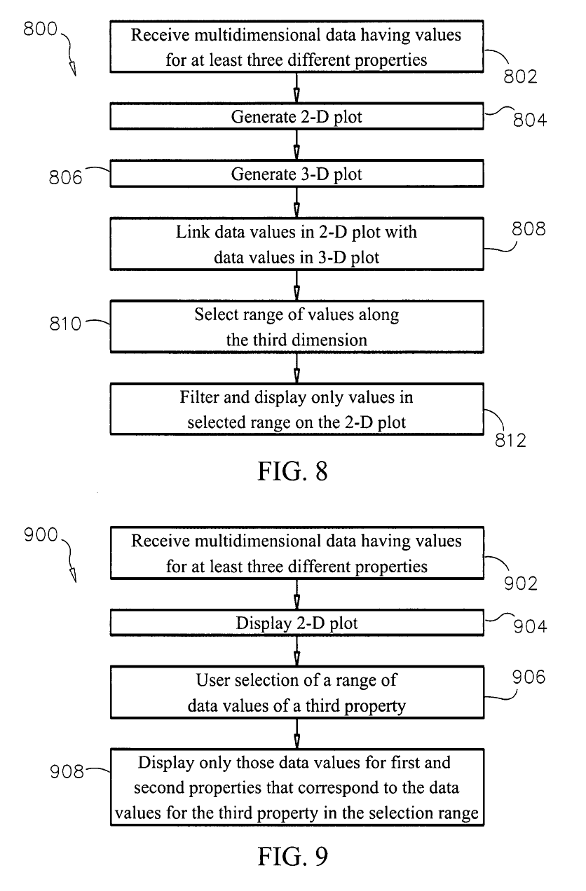

FIG. 8 illustrates an embodiment of a process 800 for representing multidimensional data derived from molecular separation processing to resemble a two-dimensional display created from a molecular separation process producing data values for two different properties and for manipulating representations resembling the two-dimensional display via a representation of at least a third dimension of data. At event 802, multidimensional data having values for at least three different properties of molecules separated by the molecular separation processing are received by the system.

A two-dimensional plot of the data values is generated for a first of the at least three different properties relative to data values for a second of the at least three different properties in a two-dimensional plot at event 804. The first and second of the properties are the same properties as those plotted in the two-dimensional displays created from a molecular separation process producing values for two different properties. A three-dimensional plot is generated at event 806. The data values for the first and second of the properties are plotted along first and second dimensions of the three-dimensional plot to correspond to the plotted first and second properties of the two dimensional plot, and data values of a third property of the at least three different properties are plotted along a third dimension of the three-dimensional plot. Data values plotted in the two-dimensional plot are linked with data values plotted in the three dimensional plot (event 806).

Once the data values are linked, a range of data values can be selected along the third dimension in the three-dimensional plot, or by using a selection feature provided with the 2-D plot. The full data set is then filtered based on the selected range of data values, and the filtered data values are plotted in the two-dimensional plot so that only data values in the range selected along the third dimension are represented in the two-dimensional plot.

FIG. 9 illustrates an embodiment of a process 900 for displaying and manipulating multidimensional data derived from molecular separation processing. At event 902, multidimensional data having data values for at least three different properties of molecules separated by the molecular separation processing are received by the system. Data values for a first of the at least three different properties relative to data values for a second of the at least three different properties are displayed in a two-dimensional plot at event 904. The data values are displayed to resemble two-dimensional displays created from a molecular separation process producing data values for only two different properties. The first and second of the properties are the same properties as those plotted in the two-dimensional displays created from a molecular separation process producing values for only two different properties.

At event 906, a user selects a range of data values of a third property of the at least three different properties. Only those data values for the first and second of the properties that correspond to the data values for the third of the properties having been selected are displayed at event 908.

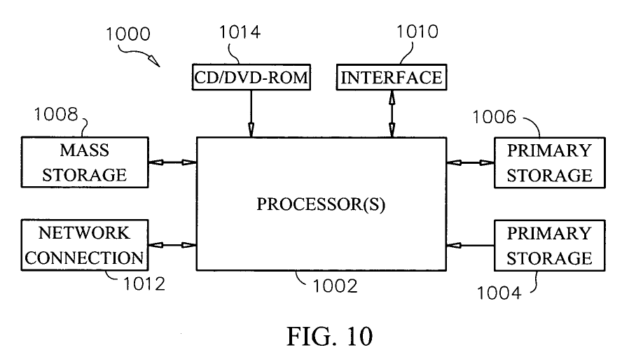

FIG. 10 illustrates a typical computer system 1000 in accordance with an embodiment of the present invention. The computer system 1000 may be incorporated into a MDLC system, or may be configured to receive multidimensional data as described in the processes herein, via interface 1010, for example, and with user interaction via user interface 600 that may be includes as one of the interfaces 1010 of the system 1000. Computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). Primary storage 1004 acts to transfer data and instructions uni-directionally to the CPU and primary storage 1006 is used typically to transfer data and instructions in a bi-directional manner. Both of these primary storage devices may include any suitable computer-readable media such as those described above. A mass storage device 1008 is also coupled bi-directionally to CPU 1002 and provides additional data storage capacity and may include any of the computer-readable media described above. Mass storage device 1008 may be used to store programs, such as plotting programs, programs for filtering the multidimensional data with input from user interface 600, data and the like and is typically a secondary storage medium such as a hard disk that is slower than primary storage. It will be appreciated that the information from primary storage 1006, may, in appropriate cases, be stored on mass storage device 1008 as virtual memory to free up space on primary storage 1006, thereby increasing the effective memory of primary storage 1006. A specific mass storage device such as a CD-ROM or DVD-ROM 1014 may also pass data uni-directionally to the CPU.

CPU 1002 is also coupled to an interface 1010 that includes one or more input/output devices such as video monitors, user interface 600, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to a computer or telecommunications network using a network connection as shown generally at 1012. With such a network connection, it is contemplated that the CPU might receive information from the network, or might output information to the network in the course of performing the above-described method steps. The above-described devices and materials are known in the computer hardware and software arts.

The hardware elements described above may operate in response to the instructions of multiple software modules for performing the operations of this invention. For example, instructions for filtering and plotting methods and settings may be stored on mass storage device 1008 or 1014 and executed on CPU 1008 in conjunction with primary memory 1006.

While the present invention has been described with reference to the specific embodiments thereof, it should be understood that various changes may be made and equivalents may be substituted without departing from the scope of the invention defined by the claims.

We claim:

1. A method of representing multidimensional data derived from molecular separation processing to resemble a two-dimensional display created from a two-dimensional molecular separation process producing data values for two different properties, the method comprising:
receiving multidimensional data values for at least three different properties of molecules separated by the molecular separation processing;
plotting the data values for a first of the at least three different properties relative to data values for a second of the at least three different properties in a two-dimensional plot, wherein the first and second of the properties are the same properties as those plotted in the two-dimensional display created from the two-dimensional molecular separation process producing values for two different properties; and
representing data values for a third of the at least three different properties by varying a graphic representation of the data values plotted for the first and second of the properties.

2. The method of claim 1, wherein the at least three different properties comprises at least four different properties, the method further comprising representing data values for a fourth of the properties by varying the graphic representation of the data values plotted for the first, second and third properties.

3. The method of claim 1, wherein the first and second of the properties are isoelectric point (pI) and molecular weight.

4. The method of claim 1, further comprising displaying a plot of said data values having been plotted and represented by said plotting and said representing.

5. The method of claim 1, wherein the third of the properties is abundance.

6. The method of claim 1, wherein the third of the properties comprises a meta-data category having metadata values associated with the data values for the first two different properties.

7. The method of claim 6, wherein the metadata category comprises a measure of reliability of the data values.

8. A method of processing and representing multidimensional data derived from molecular separation processing to resemble a two-dimensional display created from a two-dimensional molecular separation process producing data values for two different properties and for manipulating representations resembling the two-dimensional display via a representation of at least a third dimension of data, the method comprising:
receiving multidimensional data having values for at least three different properties of molecules separated by the molecular separation processing;
plotting a two-dimensional plot of the data values for a first of the at least three different properties relative to data values for a second of the at least three different properties in a two-dimensional plot, wherein the first and second of the properties are the same properties as those plotted in the two-dimensional display created from the two-dimensional molecular separation process producing values for two different properties;
plotting a three-dimensional plot wherein the data values for the first and second of the properties are plotted along first and second dimensions of the three-dimensional plot to correspond to the plotted first and second of the properties of the two dimensional plot, and data values of a third property of the at least three different properties are plotted along a third dimension of the three-dimensional plot;
linking data values plotted in said two-dimensional plot with data values plotted in said three dimensional plot;
selecting a range of data values along said third dimension in said three-dimensional plot; and
filtering the data values plotted in said two-dimensional plot so that only data values in the range selected along the third dimension in the three-dimensional plot are represented in the two-dimensional plot.

9. The method of claim 8, further comprising displaying said two-dimensional plot after said filtering.

10. The method of claim 8, further comprising simultaneously displaying said three dimensional plot, with an indication of the range of values that have been selected along the third dimension.

11. The method of claim 8, wherein the first and second properties are isoelectric point (pI) and molecular weight, and the third property is retention time.

12. A method of displaying and manipulating multidimensional data derived from molecular separation processing, the method comprising:
receiving multidimensional data having data values for at least three different properties of molecules separated by the molecular separation processing;
displaying data values for a first of the at least three different properties relative to data values for a second of the at least three different properties in a two-dimensional plot to resemble a two-dimensional display created from a two-dimensional molecular separation process producing data values for only two different properties, wherein the first and second properties are the same properties as those plotted in said two-dimensional display;
selecting, by a user, a range of data values of a third property of the at least three different properties; and
displaying only those data values for the first and second properties that correspond to the selected range of the data values for the third property.

13. The method of claim 11, wherein said selecting is performed using a selectable feature on a user interface on which the two-dimensional plot is additionally displayed.

14. The method of claim 13, further comprising: differentiating the data values displayed in the two-dimensional plot after said selecting, on a three-dimensional plot, all the data values plotted with respect to the first, second and third properties.

15. The method of claim 12, further comprising:
displaying a three-dimensional plot wherein the data values for the first and second properties are plotted to correspond to the plotted first and second properties of the two dimensional plot, and data values of the third property are plotted along a third dimension of the three-dimensional plot; and
linking data values plotted in said two-dimensional plot with values plotted in said three dimensional plot, wherein selection is carried out by the user selecting a range of values along said third dimension in said three-dimensional plot.

16. The method of claim 12, wherein the first and second properties are isoelectric point (pI) and molecular weight, and the third property is retention time.

17. A user interface, comprising:
a display; and
software configured to process multidimensional data derived from molecular separation processing, wherein the multidimensional data has values for at least three different properties of molecules separated by the molecular separation processing, to display data values for a first of the at least three different properties relative to data values for a second of the at least three different properties in a two-dimensional plot resembling a two-dimensional display created from a two-dimensional molecular separation process producing data values for only two different properties, wherein the first and second of the properties displayed are the same properties as those plotted in said two-dimensional display;
a feature for use by a user in selecting a range of data values of a third property of the at least three different properties; and
wherein said software responds to the range selection by displaying only those data values for the first and second properties that correspond to the selected range of the data values for the third property.

18. The user interface claim 17, wherein said software is further configured to display a three-dimensional plot wherein the data values for the first and second of the properties are plotted to correspond to the plotted first and second properties of the two dimensional plot, and data values of a third property of the at least three different properties are plotted along a third dimension of the three-dimensional plot; and to link data values plotted in said two-dimensional plot with values plotted in said three dimensional plot.

19. The user interface of claim 17, wherein said feature comprises a slider.

20. The user interface of claim 18, wherein said feature comprises a slider, and wherein said software further responds to the range selection by differentiating the data values displayed in the three-dimensional plot that correspond to the data values displayed in the two-dimensional plot from other data values displayed in the three-dimensional plot.

21. The user interface of claim 18, wherein said feature comprises a third axis of the three-dimensional plot against which values of the third property are plotted, and which is range selectable by the user.

22. The user interface of claim 17, wherein the first and second properties are pI and molecular weight, and the third property is retention time.

23. A computer readable medium carrying one or more sequences of instructions for displaying and manipulating multidimensional data derived from molecular separation processing, wherein the multidimensional data has data values for at least three different properties of molecules separated by the molecular separation processing, wherein execution of the one or more sequences of instructions by one or more processors causes the one or more processors to perform a process comprising:
receiving multidimensional data having data values for at least three different properties of molecules separated by the molecular separation processing;
displaying data values for a first of the at least three different properties relative to data values for a second of the at least three different properties in a two-dimensional plot to resemble a two-dimensional display created from a two-dimensional molecular separation process producing data values for only two different properties, wherein the first and second of the properties are the same properties as those plotted in said two-dimensional display; and
in response to selection by a user of a range of data values of a third property of the at least three different properties, displaying only those data values for the first and second properties that correspond to the selected range of the data values for the third property.
